(19) United States
(12) Patent Application Publication
(10) Pub. No.: US 2024/0359912 A1
(43) Pub. Date: Oct. 31, 2024

(54) CYLINDER PROPPING SYSTEM WITH A UNIVERSAL BRACKET

(71) Applicant: Oshkosh Corporation, Oshkosh, WI (US)

(72) Inventors: Nicholas Weykamp, Oshkosh, WI (US); Jason Rice, Oshkosh, WI (US); Kevin Secker, Oshkosh, WI (US); Jerrod Kappers, Oshkosh, WI (US); Jacob Wallin, Oshkosh, WI (US); Brian Cross, Oshkosh, WI (US)

(21) Appl. No.: 18/647,631

(22) Filed: Apr. 26, 2024

Related U.S. Application Data
(60) Provisional application No. 63/462,837, filed on Apr. 28, 2023.

(51) Int. Cl. B65F 3/06

(52) U.S. Cl. CPC B65F 3/06

(57) ABSTRACT

A refuse vehicle includes a chassis, a body supported on the chassis, and a universal bracket coupled to the chassis. The universal bracket is coupled to (a) a lift cylinder assembly that is configured to lift the body relative to the chassis, or (b) a tiedown assembly that is configured to oppose movement of the body relative to the chassis. The universal bracket includes a sidewall that is coupled to a debris deflection device, a spill kit, a tire chain holder, an air dryer, a wheel chock holder, or a service lift pump.

### CROSS-REFERENCE TO RELATED PATENT APPLICATIONS

This application claims the benefit of and priority to U.S. Provisional Application No. 63/462,837, filed on Apr. 28, 2023, the entire disclosure of which is hereby incorporated by reference herein.

### BACKGROUND

Many on and off-road vehicles include components that move relative to a chassis (e.g., frame) of the vehicle to facilitate vehicle operations. Some examples of moving components include loading forks used by garbage trucks to raise and lower refuse collection containers, a front end loading mechanism for a construction vehicle (e.g., a bucket attachment for a front end loader or skid steer loader), etc. The moving components may be coupled to a cylinder assembly. The cylinder assembly may include a cylinder housing and a cylinder. A vehicle operator may extend and retract the cylinder relative to the cylinder housing to raise, lower, or otherwise manipulate the moving component of the vehicle.

In some instances, the vehicle may additionally include a propping system configured to prevent the cylinder from inadvertently retracting into the cylinder housing. For example, the propping system may be used to prevent the cylinder from retracting into the cylinder housing when the vehicle is turned off or for safety reasons to prevent the operator from accidentally lowering a heavy load while the vehicle is operating. These propping systems generally utilize long arms that rotate into contact with the fully extended cylinder. The arms are usually quite heavy (e.g., the arms may be made from steel having a large material thickness to ensure adequate support for raised components and loads) and typically require manual manipulation by the operator to activate.

### SUMMARY OF THE INVENTION

One embodiment of the present disclosure relates to a refuse vehicle. The refuse vehicle includes a chassis, a body supported on the chassis, and a universal bracket coupled to the chassis. The universal bracket is coupled to (a) a lift cylinder assembly that is configured to lift the body relative to the chassis, or (b) a tiedown assembly that is configured to oppose movement of the body relative to the chassis. The universal bracket includes a sidewall that is coupled to a debris deflection device, a spill kit, a tire chain holder, an air dryer, a wheel chock holder, or a service lift pump.

One embodiment of the present disclosure relates to a refuse vehicle. The refuse vehicle includes a chassis, a body supported on the chassis, a bracket coupled to the chassis, a lift cylinder assembly coupled between the bracket and the body, and a propping system coupled to the lift cylinder assembly. The lift cylinder assembly is configured to selectively raise and lower the body relative to the chassis. The propping system includes a pump, a tank, an accumulator, an accumulator valve, a drain valve, and a throttle drain valve. The propping system being configured to operate in a tie down mode, a body lift mode, and a body lower mode. In the tie down mode, the accumulator valve is configured to provide fluid communication between the accumulator and a rod chamber of the lift cylinder assembly. The accumulator provides a biasing force that acts in direction that opposes the body from being lifted relative to the chassis. In the body lift mode, the accumulator valve is configured to provide fluid communication between the rod chamber and the tank, the drain valve is configured to prevent fluid communication between a piston chamber of the lift cylinder assembly and the tank, and the pump is configured to supply pressurized hydraulic fluid to the piston chamber so that the body is lifted relative to the chassis. In the body lower mode, the accumulator valve is configured to provide fluid communication between the rod chamber and the tank, and the drain valve and the throttle drain valve are configured to provide fluid communication between the piston chamber and the tank through a throttle, so that the body is lowered relative to the chassis at a speed that is limited by the throttle.

One embodiment of the present disclosure relates to a propping system for a refuse vehicle. The propping system includes a lift cylinder assembly having a cylinder rod, a cylinder housing, a piston, a piston chamber defined within the cylinder housing, and a rod chamber defined within the cylinder housing, a hydraulic circuit that includes a pump, a tank, an accumulator, an accumulator valve, a drain valve, and a throttle drain valve. The hydraulic circuit is operable in a tiedown mode, a body lift mode, and a body lower mode. In the tiedown mode, the accumulator valve is configured to provide fluid communication between the accumulator and the rod chamber to provide a biasing force from the accumulator that acts in direction that opposes the cylinder rod from extending from the cylinder housing. Tn the body lift mode, the accumulator valve is configured to provide fluid communication between the rod chamber and the tank, the drain valve is configured to prevent fluid communication between the piston chamber and the tank, and the pump is configured to supply pressurized hydraulic fluid to the piston chamber so that the cylinder rod is extended from the cylinder housing. In the body lower mode, the accumulator valve is configured to provide fluid communication between the rod chamber and the tank, and the drain valve and the throttle drain valve are configured to provide fluid communication between the piston chamber and the tank through a throttle, so that the cylinder rod is retracted into the cylinder housing at a speed that is limited by the throttle.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a refuse truck including a cylinder propping system, according to an exemplary embodiment;

FIG. 2 is a perspective view of the cylinder propping system of FIG. 1, according to an exemplary embodiment;

FIG. 3A is a perspective view of the cylinder propping system of FIG. 1 in a retracted position, according to an exemplary embodiment;

FIG. 3B is a perspective view of the cylinder propping system of FIG. 1 in an extended position, according to an exemplary embodiment;

FIG. 4 is an exploded view of the cylinder propping system of FIG. 1, according to an exemplary embodiment;

FIG. 5 is a side view of the cylinder propping system of FIG. 1 and a rotating-arm type cylinder propping system, according to an exemplary embodiment;

FIG. 6 is a bottom perspective view of a locking member for the cylinder propping system of FIG. 1, according to an exemplary embodiment;

FIG. 7 is a perspective view of a universal bracket for a cylinder propping system, according to an exemplary embodiment;

FIG. 8 is a side view of the universal bracket of FIG. 7, according to an exemplary embodiment;

FIG. 9 is a front view of the universal bracket of FIG. 7, according to an exemplary embodiment;

FIG. 10 is a perspective view of a service lift pump and a spill kit coupled to the universal bracket of FIG. 7, according to an exemplary embodiment;

FIG. 11 is a side view of an adapter plate and a wheel check holder coupled to the universal bracket of FIG. 7, according to an exemplary embodiment;

FIG. 12 is a perspective view of a spill kit coupled to the universal bracket of FIG. 7, according to an exemplary embodiment;

FIG. 13 is a perspective view of a tire chain holder and a spill kit coupled to the universal bracket of FIG. 7, according to an exemplary embodiment;

FIG. 14 is a perspective view of two spill kits coupled to the universal bracket of FIG. 7, according to an exemplary embodiment;

FIG. 15 is a perspective view of an air dryer and a spill kit coupled to the universal bracket of FIG. 7, according to an exemplary embodiment;

FIG. 16 is a side view of the universal bracket of FIG. 7 including a tie down assembly, according to an exemplary embodiment;

FIG. 17 is a side view of the universal bracket of FIG. 7 including a removable tie down strut, according to an exemplary embodiment;

FIG. 18 is a perspective view of the universal bracket of FIG. 7 installed on a refuse truck, according to an exemplary embodiment;

FIG. 19 is a perspective view of the universal bracket of FIG. 7 including open apertures in bolt connecting members, according to an exemplary embodiment;

FIG. 20 is a perspective view of a hydraulic quick-disconnect fitting coupled to the universal bracket of FIG. 7, according to an exemplary embodiment;

FIG. 21 is a perspective view of a cylinder propping system and a lift cylinder assembly mounted on a refuse truck, according to an exemplary embodiment;

FIG. 22 is a perspective view of a lift cylinder assembly of the cylinder propping system of FIG. 21 with a sleeve of the cylinder propping system being transparent, according to an exemplary embodiment; and

FIG. 23 is a schematic of a hydraulic circuit of the cylinder propping system of FIG. 21, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a vehicle includes a cylinder propping system configured to prevent movement of a vehicle component in at least one position. The vehicle includes a cylinder assembly coupled to the vehicle component. The cylinder assembly includes a cylinder housing and a cylinder. The cylinder is configured to move relative to the cylinder housing to manipulate a position of the vehicle component. The propping system is configured to engage with the cylinder housing in the at least one position to prevent movement of the cylinder relative to the cylinder housing. The propping system includes a sleeve configured to receive the cylinder assembly. The sleeve surrounds (e.g., circumferentially surrounds, etc.) the cylinder assembly such that the cylinder assembly is substantially enclosed within (e.g., covered by) the sleeve, which, advantageously, minimizes the overall size of the propping system. The sleeve also prevents access to the interface between the cylinder and the cylinder housing, thereby reducing the risk of injury to a vehicle operator while the cylinder assembly is in operation.

The propping system includes a locking member configured to engage with the cylinder housing and an upper ledge of the sleeve to prevent the cylinder housing from retracting into the sleeve. To engage the propping system, an operator simply places the locking member on the upper ledge of the sleeve, in between the cylinder housing and the upper ledge edge of the sleeve. When placed upon the upper ledge of the sleeve, the locking member is forced up against, and engages with, a circumferential portion of the cylinder. The amount of effort required to engage the propping system is much less than conventional propping systems, which typically require the operator to manipulate large and heavy support structures (e.g., arms, etc.) that are approximately equal in length to the cylinder.

Among other advantageous features, the sleeve may include a slot configured to receive the locking member therein when “locking out” the cylinder assembly to help prevent the locking member from becoming dislodged from the sleeve. Additionally, the locking member may be configured to engage with a support member or locking tab disposed on the sleeve to further prevent the locking member from becoming separated from the sleeve once engaged with the cylinder. In some embodiments, the sleeve may include multiple slots along a length of the sleeve to secure the cylinder assembly (e.g., housing) in different positions relative to the sleeve. These and other advantageous features will become apparent to those reviewing the present disclosure and figures.

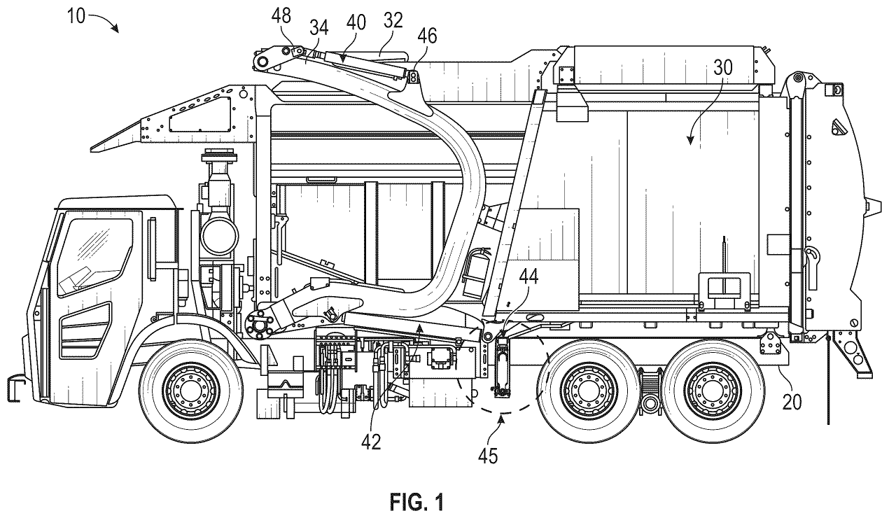

Referring to FIG. 1, a vehicle, shown as vehicle 10, includes a vehicle chassis, shown as chassis 20 (e.g., frame, etc.) and a vehicle body, shown as body 30 coupled thereto. The vehicle 10 may be configured as an on-road vehicle or an off-road vehicle. In one embodiment, the vehicle is an off-road construction vehicle such as a skid steer, excavator, or front-end loader. In other embodiments, the vehicle is a mobile crane or cement truck. In the exemplary embodiment of FIG. 1, the vehicle 10 is a refuse truck (e.g., a garbage truck, a waste collection truck, a sanitation truck, etc.) configured to transport refuse from various waste receptacles within a municipality to a storage and/or processing facility (e.g., a landfill, an incineration facility, a recycling facility, etc.).

As shown in FIG. 1, the vehicle 10 includes a plurality of components that are movably coupled to the chassis 20. In other words, the vehicle 10 includes a plurality of components that may move relative to the chassis 20 to facilitate vehicle operations. For example, the vehicle 10 includes a set of forks 32 used to engage the vehicle 10 with a refuse container. The forks 32 are hingedly coupled to a support frame 34 such that the forks 32 rotate relative to the support frame 34. The support frame 34 is hingedly coupled to the body 30. The forks 32 and support frame 34 may be used to empty the contents of the refuse container into the body 30 by lifting the refuse container up and over the body 30 and/or tilting the refuse container. The vehicle 10 also includes a lift system used to reposition the body 30 relative to the chassis 20 (e.g., to raise and lower the body 30 such that a gap is formed between the body 30 and the chassis 20). Among other benefits, the lift system may be used by a technician or operator to access vehicle components (e.g., hydraulic system components, electrical system components, etc.) located beneath the body 30, and to thereby facilitate maintenance operations for the vehicle 10.

As shown in FIG. 1, the vehicle 10 includes a plurality of cylinder assemblies configured to manipulate a position of a vehicle component relative to other parts of the vehicle. As shown in FIG. 1, the vehicle 10 includes a first cylinder assembly 40 configured to manipulate a position of the forks 32 relative to the support frame 34, a second cylinder assembly 42 configured to manipulate a position of the support frame 34 relative to the body 30, and a third cylinder assembly, shown as lift cylinder assembly 44 configured to manipulate a position of the body 30 relative to the chassis 20. In other embodiments, the vehicle 10 includes additional, fewer, and/or different numbers and/or arrangements of cylinder assemblies. As shown in FIG. 1, each of the first cylinder assembly 40, the second cylinder assembly 42, and the lift cylinder assembly 44 includes a cylinder housing and a cylinder slidably engaged with the cylinder housing. A first end of the cylinder is disposed in an internal cavity defined by the cylinder housing. A second end of the cylinder extends beyond (e.g., outwardly from, away from, etc.) the cylinder housing. The cylinder is configured to move (e.g., slide) relative to the cylinder housing, into and out of the cylinder housing, in a direction that is substantially parallel to an axis of the cylinder housing. The cylinder is repositionable between a retracted position in which a substantial portion of the cylinder is contained within the internal cavity of the cylinder housing, and an extended position in which the cylinder is moved away from (e.g., extends substantially outwardly from, is positioned substantially outside of, etc.) the cylinder housing.

As shown in FIG. 1, the first cylinder assembly 40, the second cylinder assembly 42, and the lift cylinder assembly 44 are used to reposition the movable components, including the forks 32, the support frame 34, and the body 30, respectively, of the vehicle 10. Each of the first cylinder assembly 40, the second cylinder assembly 42, and the lift cylinder assembly 44 includes a first end and a second end disposed (e.g., positioned, located, etc.) opposite the first end. The first end is coupled to one of the stationary components of the vehicle 10 (e.g., a non-movable component, a component that the movable component is secured and/or positioned relative to, a component that is stationary relative to the vehicle chassis, etc.). The second end of each of the first cylinder assembly 40, the second cylinder assembly 42, and the lift cylinder assembly 44 is coupled to a moving component of the vehicle 10 such as the forks 32, the support frame 34, and the body 30. For example, as shown in FIG. 1, a first end 46 of the first cylinder assembly 40 (used to reposition the forks 32) is hingedly coupled to the support frame 34. A second end 48 of the first cylinder assembly 40 is hingedly coupled to the forks 32. In the exemplary embodiment of FIG. 1, the first end 46 of the first cylinder assembly 40 is integrally formed with the cylinder housing, while the second end 48 of the first cylinder assembly 40 is integrally formed with the cylinder (e.g., the second end of the cylinder). In other embodiments, the configuration may be reversed (e.g., the first end 46 is integrally formed with the cylinder, while the second end 48 is integrally formed with the cylinder housing).

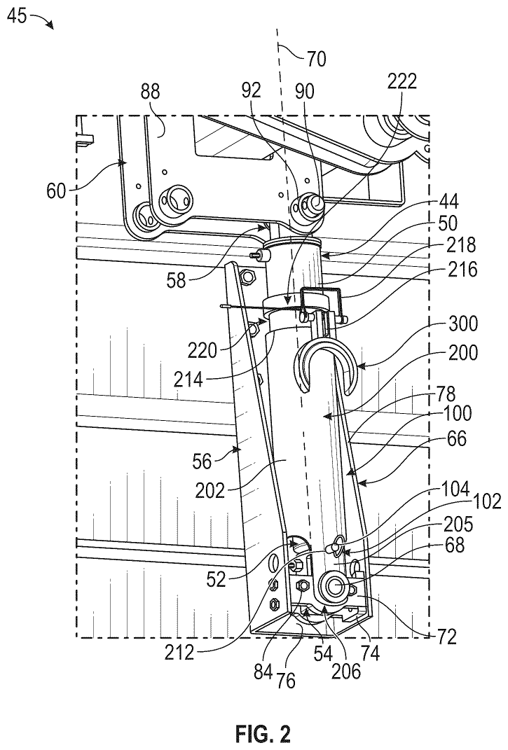

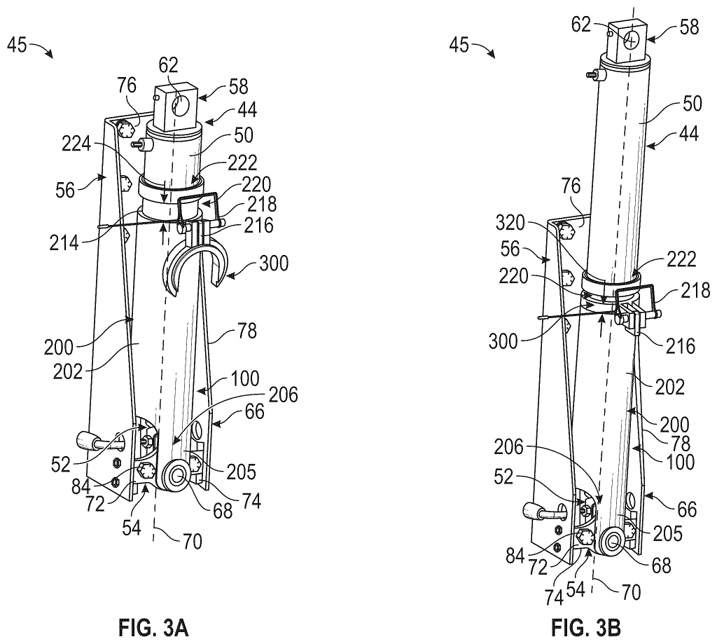

Referring now to FIG. 2, a lift system 45 is shown, according to an exemplary embodiment. The lift system 45 is used to reposition (e.g., raise or lower) the body 30 relative to the chassis 20 of the vehicle 10. As shown in FIGS. 2, the lift system 45 includes the lift cylinder assembly 44 and a cylinder propping system, shown as propping system 100. The lift cylinder assembly 44 includes a cylinder housing 50 and a cylinder or rod 52 slidably engaged to the cylinder housing 50. Referring to FIGS. 3A-3B, the cylinder assembly 44 is reconfigurable between a retracted position in which a substantial portion of the cylinder 52 is contained within the cylinder housing 50 (FIG. 3A), and an extended position in which the cylinder 52 is moved away from (e.g., extends substantially outwardly from, positioned substantially outside of, etc.) the cylinder housing 50 (FIG. 3B). In the retracted position, as shown in FIG. 3A, the cylinder housing 50 is substantially surrounded by (e.g., contained substantially within, etc.) a sleeve 200 of the propping system 100. The sleeve 200 extends along a length of the cylinder assembly 44, in a direction substantially parallel to an axis 70 (e.g., a central axis) of the cylinder assembly 44. A length of the sleeve 200 is approximately equal to a length of the cylinder 52 and cylinder housing 50. As shown in FIG. 3B, the length of the sleeve 200, determines, in part, the maximum amount of extension of the cylinder housing 50 relative to the cylinder 52 that can be supported by the propping system 100.

The lift cylinder assembly 44 and the propping system 100 may be mounted to the vehicle 10 in a variety of different ways. In the exemplary embodiment of FIG. 2, the lift system 45 includes bracket assemblies, shown as chassis bracket assembly 56 and body bracket assembly 60, which are used to couple the lift cylinder assembly 44 to the chassis 20 and the body 30, respectively. A first end 54 of the lift cylinder assembly 44 is mechanically coupled to chassis bracket assembly 56, which is mechanically coupled (e.g., affixed, fastened, etc.) to the chassis 20 of the vehicle 10. A second end 58 of the lift cylinder assembly 44 is coupled to a body bracket assembly 60, which is mechanically coupled (e.g., affixed, fastened, etc.) to the body 30 of the vehicle 10. In some embodiments, each end 54, 58 of the lift cylinder assembly 44 may be permanently affixed to a corresponding one of the chassis bracket assembly 56 and the body bracket assembly 60. In other embodiments, each end (e.g., the first end 54 and the second end 58) of the lift cylinder assembly 44 may be coupled directly to the chassis 20 or the body 30, rather than utilizing intermediate bracket assemblies (e.g., the chassis bracket assembly 56 and the body bracket assembly 60). In the exemplary embodiment of FIG. 2, each end (e.g., the first end 54 and the second end 58) of the cylinder assembly 44 is hingedly coupled to a corresponding one of the chassis bracket assembly 56 and the body bracket assembly 60, such that the lift cylinder assembly 44 may rotate relative to the chassis bracket assembly 56 and the body bracket assembly 60. Among other benefits, hingedly coupling the first end 54 and the second end 58 of the lift cylinder assembly 44 to the chassis bracket assembly 56 and the body bracket assembly 60, respectively, can reduce stress on the lift cylinder assembly 44 during normal operation (e.g., by allowing for small amounts of rotation to accommodate any misalignment between the chassis 20 and the body 30, etc.).

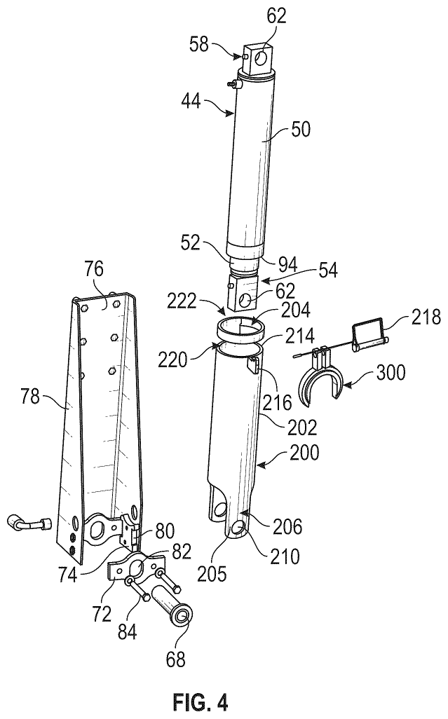

Referring now to FIG. 4, the cylinder assembly 44 includes a first end opening 62 configured to couple the first end 54 of the cylinder assembly 44 to the chassis bracket assembly 56 and a second end opening 64 configured to couple the second end 58 of the cylinder assembly 44 to the body bracket assembly 60. The first end opening 62 is disposed on an exposed end of the cylinder 52 that is positioned outside of the cylinder housing 50 when the lift cylinder assembly is in a fully retracted position. The second end opening 64 is disposed on an end of the cylinder housing 50 on an opposing end of the lift cylinder assembly 44. In the exemplary embodiment of FIG. 4, the first end opening 62 and the second end opening 64 are substantially circular and extend through the cylinder assembly 44, in a direction that is substantially normal to an axis 70 of the lift cylinder assembly 44. In other embodiments, a different fastening mechanism may be used to secure the lift cylinder assembly 44 to the vehicle 10.

As shown in FIGS. 4, the chassis bracket assembly 56 includes a bracket 66, an end bolt 68, and a plurality of connecting members, including a bolt connecting member 72 and a side wall connecting member 74 arranged in substantially perpendicular orientation with respect to the bolt connecting member 72. The bracket 66 includes a base wall 76 and two side walls 78 extending substantially perpendicular to the base wall 76. Together, the base wall 76 and the two side walls 78 form a C-channel sized to receive the lift cylinder assembly 44 and the propping system 100 for the lift cylinder assembly 44. The base wall 76 includes a plurality of holes disposed proximate to an upper end of the bracket assembly 56, by which the base wall 76 may be fastened to the chassis 20 of the vehicle 10 (e.g., by using bolts, screws, or another suitable fastener). In other embodiments, the base wall 76 may be welded or otherwise coupled to the chassis 20. In the exemplary embodiment of FIG. 2, the first end 54 of the lift cylinder assembly 44 is coupled to the side walls 78 proximate to a lower end of the bracket assembly 56. A length of the bracket assembly 56, parallel to the central axis 70, is greater than the length of the sleeve 200 such that the bracket assembly 56 surround at least a portion of the sleeve 200 along an entire length of the sleeve 200. The bracket assembly 56 is sized to accommodate the length of the lift cylinder assembly 44 in the retracted position. As shown in FIG. 4, one of the side walls 78 includes an aperture configured to receive a hydraulic line. In other embodiments, the side walls 78 may include one or more apertures or holes configured to receive and/or support other plumbing or electrical components (e.g., wiring, etc.).

In the exemplary embodiment of FIG. 4, the bracket assembly 56 includes a plurality of connecting members, shown as bolt connecting members 72, and side wall connecting members 74. Together, the bolt connecting member 72 and the side wall connecting members 74 are configured to secure the first end 54 of the cylinder assembly 44 (and a first end 206 of the sleeve 200) in position relative to the bracket assembly 56. In the exemplary embodiment of FIG. 3, the chassis bracket assembly 56 includes two side wall connecting members 74 and two bolt connecting members 72. Each of the side wall connecting members 74 is coupled (e.g., fastened, etc.) to an inside edge of a side wall 78 proximate to the lower end of the chassis bracket assembly 56. The side wall connecting members 74 include recessed portions 80, which are configured to engage with the bolt connecting members 72 to facilitate alignment between the bolt connecting members 72 and the side wall connecting members 74. The recessed portions 80 also prevent vertical movement of the bolt connecting members 72 relative to the bracket assembly 56 (e.g., movement of the bolt connecting members 72 in a direction that is substantially parallel to the axis 70 of the cylinder assembly 44, etc.).

In the exemplary embodiment of FIG. 4, the bolt connecting members 72 extend between the side walls 78 of the bracket assembly 56, in a direction that is substantially perpendicular to the side walls 78. The bolt connecting members 72 include an aperture 82 positioned at an intermediate position between the side walls 78 (e.g., approximately half way between the side walls 78, at a central position between the side walls 78, etc.). The aperture 82 of each bolt connecting member 72 is configured to receive an end bolt 68 therethrough. The bolt connecting members 72 are fastened together by bolts 84, that pull the bolt connecting members 72 toward one another, and against the recessed portions 80 of the side wall connecting members 74. The side wall connecting members 74 are “sandwiched” or otherwise positioned between the bolt connecting members 72 such that a gap 86 is formed therebetween. The first end 54 of the lift cylinder assembly 44 is secured in position within the gap 86 by the end bolt 68, which passes through the apertures 82 of the bolt connecting members 72 and the first end opening 62.

Referring now to FIG. 2, the second end 58 of the lift cylinder assembly 44 (e.g., an end of the cylinder housing 50) is coupled to the body bracket assembly 60. The second end 58 of the lift cylinder assembly 44 is disposed in a space formed between a pair of substantially parallel support members 88. In the exemplary embodiment of FIG. 2, a second eyebolt 90 is inserted into a through-hole 92 of the support members 88 and into the second end opening 64 to secure the second end 58 of the lift cylinder assembly 44 in position relative to the body 30. In other embodiments, the coupling mechanism between the lift cylinder assembly 44 and the body 30 of the vehicle 10 may be different. In some embodiments, the orientation of the lift cylinder assembly 44 and the propping system 100 may be reversed such that the second end 58 of the lift cylinder assembly 44 is coupled to the chassis bracket assembly 56 and the first end 54 of the lift cylinder assembly 44 is coupled to the body bracket assembly 60 (e.g., the lift cylinder assembly 44 and propping system 100 flipped 180° from the orientation shown in FIG. 2). In other embodiments, the orientation of the lift system 45 may be reversed such that the chassis bracket assembly 56 is secured to the body 30 and the body bracket assembly 60 is secured to the chassis 20.

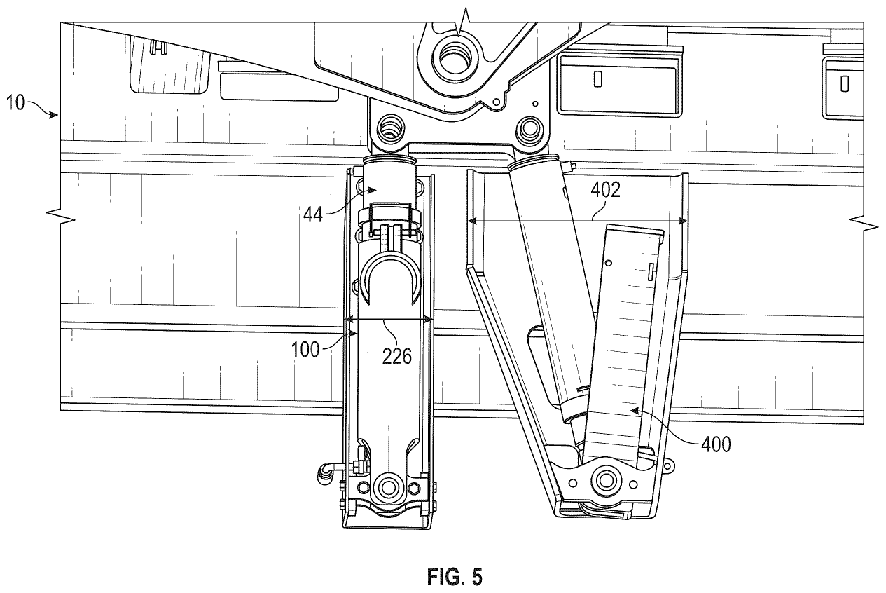

The propping system 100 is configured to engage with the lift cylinder assembly 44 in at least one position to prevent the cylinder 52 from retracting into the cylinder housing 50. As shown in FIGS. 4, the propping system 100 includes a sleeve 200 and a locking member 300. The sleeve 200 includes a substantially cylindrical outer wall 202 (e.g., a cylindrical tube, etc.) defining a cavity 204. The cavity 204 is configured to receive at least a portion of the lift cylinder assembly 44 therein. An inner diameter of the cavity 204 is larger than an outer diameter of the cylinder housing 50 so as to accommodate the cylinder housing 50. As shown in FIGS. 2 and 3A, in the retracted position, the sleeve 200 substantially surrounds (e.g., circumferentially surrounds) the cylinder housing 50. Among other benefits, utilizing a sleeve 200 that surrounds the lift cylinder assembly 44, as opposed to a cylinder propping member (e.g., arm or other member configured to engage with the cylinder housing 50 in the extended position), significantly reduces the size of the lift system 45. By way of example, FIG. 5 shows a size comparison of the propping system 100 and a rotating-arm type propping system 400 in which an arm is rotated into place over an extended cylinder to prevent the cylinder from retracting into a cylinder housing. In the comparison shown, the rotating-arm type propping system 400 has an overall width 402, substantially parallel to a longitudinal axis of the vehicle 10 (e.g., front to back), of approximately 14.3 in., whereas the propping system 100 of the present disclosure has an overall width 226 of approximately 5.7 in. In other words, because the propping system 100 does not include any rotating members, the overall width 226 can be substantially reduced.

The outer wall 202 of the sleeve 200 is coupled to the cylinder 52 and secured in position relative to the cylinder 52. In the exemplary embodiment of FIGS. 2-4, the sleeve 200 includes a pair of extension pieces 205 (e.g., cars, tabs, etc.) proximate to a first end 206 of the sleeve 200. The extension pieces 205 extend in a direction oriented substantially parallel to an axis 208 (e.g., central axis, etc.) of the sleeve 200. An end bolt 68 is configured to engage with the extension pieces 205 to secure the first end 206 of the sleeve 200 in position with respect to the chassis bracket assembly 56. In the exemplary embodiment of FIGS. 2-4, the end bolt 68 is received within an opening 210 passing through each of the extension pieces 205 so as to hingedly couple the sleeve 200 to the chassis bracket assembly 56. As shown in FIGS. 2-3B, each extension piece 205 is separated from the first end 54 of the lift cylinder assembly 44 by one of the bolt connecting members 72. In other embodiments, one or more extension pieces 205 may be disposed in the gap 86 between the bolt connecting members 72. In yet other embodiments, the extension pieces 205 may be directly coupled to the side walls 78. In yet other embodiments, the extension pieces 205 may be coupled to a plurality of connecting members separate from the bolt connecting members 72 and the side wall connecting members 74.

In the exemplary embodiment of FIGS. 2, the propping system 100 includes a locating member 102 configured to prevent the sleeve 200 from rotating relative to the lift cylinder assembly 44 to prevent the sleeve 200 from inadvertently contacting the cylinder 52 and/or the cylinder housing 50. The locating member 102 includes a locating pin 104. The locating pin 104 extends through a locating hole, shown as hole 212 in the sleeve 200 and into an opening (not shown) in the cylinder 52. In other embodiments, the sleeve 200 may include internal ribs or protrusions proximate the first end 206 of the sleeve 200 that are configured to center the sleeve 200 with respect to the cylinder 52. In yet other embodiments, the sleeve 200 and/or lift cylinder assembly 44 may include another type of centering and/or positioning feature configured to position the lift cylinder assembly 44 within the sleeve 200.

In the exemplary embodiment of FIGS. 2-4, the propping system 100 includes a locking member 300. The locking member 300 is configured to engage with the sleeve 200 and the cylinder housing 50 to prevent the cylinder housing 50 from retracting into the sleeve 200 when the cylinder assembly 44 is in an extended position (and to prevent the cylinder 52 from retracting into the cylinder housing 50). In an exemplary embodiment, a first side 302 of the locking member 300 is configured to engage with (e.g., contact, etc.) an upper ledge 214 of the sleeve 200. A second side 304 of the locking member 300, opposite the first side 302, is configured to engage with (e.g., contact, etc.) an end surface 94 of the cylinder housing 50.

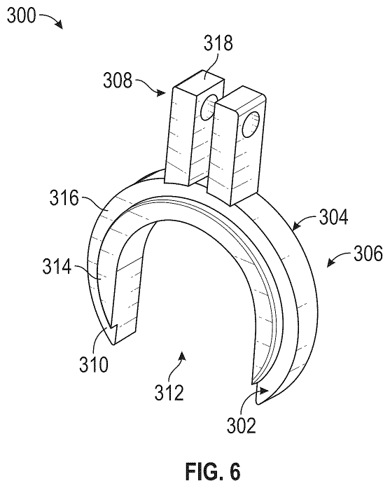

Referring now to FIG. 6, the locking member 300 includes an interface portion 306 and a retaining portion 308 coupled thereto. The locking member 300 may be made from a single piece of material or multiple pieces of material that are welded or otherwise coupled together. In the exemplary embodiment of FIG. 6, the interface portion 306 is substantially cylindrical (e.g., the edges at an outer perimeter of the interface portion 306 are curved). In other embodiments, the interface portion 306 may be substantially rectangular (e.g., the edges may be configured in the shape of a tuning fork, etc.) or another shape that prevents the cylinder housing 50 from retracting into the sleeve 200.

The interface portion 306 includes two extensions 310 (e.g., forks, etc.) forming a receiving slot 312. The receiving slot 312 is configured to receive the cylinder 52 (e.g., the shaft of the cylinder) and at least partially surround the cylinder 52. In the exemplary embodiment of FIG. 6, the receiving slot 312 is substantially U-shaped and is configured to surround the cylinder 52 along a circumferential portion of the cylinder 52 (e.g., a 180° portion of an outer perimeter of the cylinder 52, etc.). Among other benefits, using a U-shaped receiving slot 312 ensures a larger contact area between the second side 304 of the locking member and an end surface of the cylinder housing 50. In other embodiments, the receiving slot 312 may be V-shaped, rectangular, or another shape. In some embodiments, the interface portion 306 may be configured to circumferentially surround (e.g., wrap around, encircle, etc.) a smaller portion of the cylinder 52.

In the exemplary embodiment of FIG. 6, the interface portion 306 includes a protrusion 314 forming a step 316 (e.g., a ledge, etc.) along the first side 302 of the locking member 300. An outer diameter of the protrusion is less than an inner diameter of the sleeve 200 such that the protrusion may be at least partially received within the cavity 204 of the sleeve 200. Among other benefits, the protrusion 314 helps to prevent the locking member 300 from becoming dislodged from (e.g., falling out of, etc.) the sleeve 200 once positioned on the upper ledge 214 of the sleeve 200. The step 316 is configured to contact the upper ledge 214 of the sleeve 200 such that any forces applied to the locking member 300, by the lift cylinder assembly 44, are transmitted through the locking member 300 to the sleeve 200.

The retaining portion 308 of the locking member 300 is configured to secure the locking member 300 to a support member 216 (e.g., a tab, etc.) disposed on the sleeve 200 (see also FIGS. 2-4). Among other benefits, the support member 216 prevents the locking member 300 from becoming dislodged or being inadvertently removed when positioned between the sleeve 200 and the cylinder housing 50. In the exemplary embodiment of FIG. 6, the retaining portion 308 includes two substantially parallel posts 318 that extend from the interface portion 306. The posts 318 extend away from the receiving slot 312 of the interface portion 306. As shown in FIGS. 2-3B, the support member 216 is received in between the posts 318. The locking member 300 is hingedly coupled to the sleeve 200 by a retaining clip 218 (see FIGS. 2-4) that passes through a hole that extends through an end of the posts 318 and through the support member 216. When the locking member 300 is not in use (e.g., when the locking member 300 is removed from the upper ledge 214 of the sleeve 200, when the cylinder assembly 44 is in the retracted position as shown in FIGS. 2-3A, etc.), the support member 216 may be utilized to maintain the locking member 300 in an easily accessible position alongside the sleeve 200. In other embodiments, the retaining portion 308 may only include a single post configured to engage with the support member 216. In yet other embodiments, a different type of retaining mechanism (e.g., clip, bolt, etc.) may be used to prevent the locking member 300 from being inadvertently removed from the sleeve 200.

According to an exemplary embodiment, as shown in FIG. 4, the sleeve 200 includes a slot, shown as slot 220, configured to receive the locking member 300 therein. The slot 220 is disposed at an intermediate position between opposing ends of the sleeve 200. In the embodiment of FIG. 4, the slot 220 is disposed proximate to a second end 222 of the sleeve 200. In other embodiments, the position of the slot 220 along the sleeve 200 may be different. The position of the slot 220 determines a position at which the cylinder housing 50 is supported by the locking member 300 (e.g., an extended position of the cylinder assembly 44). As shown in FIGS. 3A-3B, the slot 220 extends through the outer wall of the sleeve 200 in a direction that is substantially normal to the axis 208 of the sleeve 200. A height 224 of the slot 220, in a direction substantially parallel to the axis 208 of the sleeve 200, is slightly larger than a height 320 of the interface portion 306 of the locking member 300. Among other benefits, the slot 220 helps to position the locking member 300 and prevents the locking member 300 from becoming dislodged from the sleeve 200 once positioned on a ledge of the slot 220 (e.g., the slot 220 prevents the locking member 300 from rotating up and away from the cylinder 52 when the lift cylinder assembly 44 is in the extended position). The support member 216 is disposed proximate to the slot 220, so that the retaining portion 308 (e.g., posts 318) may be coupled to the support member 216 when the locking member 300 is engaged with the slot 220.

In other exemplary embodiments, the sleeve 200 includes a plurality of slots 220 to provide more than one position at which the cylinder housing 50 may be secured relative to the sleeve 200. Among other benefits, the slots provide a mechanism for adjustment of the position at which the cylinder housing 50 is supported, which may be beneficial in operating conditions where less than a full extension of the lift cylinder assembly 44 is required.

The propping system 100, of which various exemplary embodiments are disclosed herein, provides several advantages over conventional cylinder propping systems. Among other benefits, the propping system 100 occupies a much smaller volume of space than conventional systems. The more compact arrangement allows the propping system 100 to be integrated into smaller vehicles and/or areas in the vehicle that are space limited. In addition, operation of the propping system 100 does not require multiple users, or movement of large and heavy components that are similar in size to the cylinder assembly being supported. Rather, a user or operator may perform locking operations by manipulating a locking member 300 that is only a small fraction of the size of the supported components.

According to an exemplary embodiment, the vehicle 10 includes a universal bracket that couples a plurality of components to that chassis 20. By way of example, the propping system 100 may include a universal bracket that supports the lift cylinder assembly 44 and the sleeve 200 between the chassis 20 and the body 30, and that couples additional components to the chassis 20. The additional components may include a service lift, a body hold down, a body guide, a debris deflection device (e.g., mudflap, a quarter fender, etc.), a triangle kit, a spill kit, tire chains, and/or an air dryer. By way of example, the universal bracket may include one or more mounting apertures and/or one or more mounting adapter plates that facilitate additional components being coupled thereto. Because the universal bracket is coupled to the chassis 20, the additional components coupled to the universal bracket are also supported by the chassis 20. As such, the universal bracket may free up space along the chassis 20 by coupling several components to a single universal bracket, rather than having individual mounting brackets for each component supported along the chassis 20.

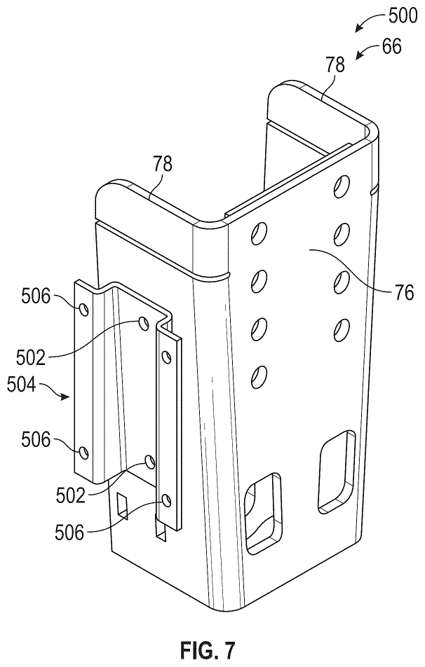

FIG. 7 shows an exemplary embodiment of the bracket 66 configured as a universal bracket 500. The universal bracket 500 is similar to the bracket 66, with similar elements identified using like reference numerals, except as described herein or apparent from the figures. In some embodiments, the universal bracket 500 includes mounting apertures 502 that are arranged on both of the sidewalls 78 and extend through the corresponding sidewall 78. By way of example, the mounting apertures 502 may facilitate the coupling of an additional component directly to the universal bracket 500 or the coupling of an adapter plate 504 to the universal bracket 500 as shown in FIG. 7.

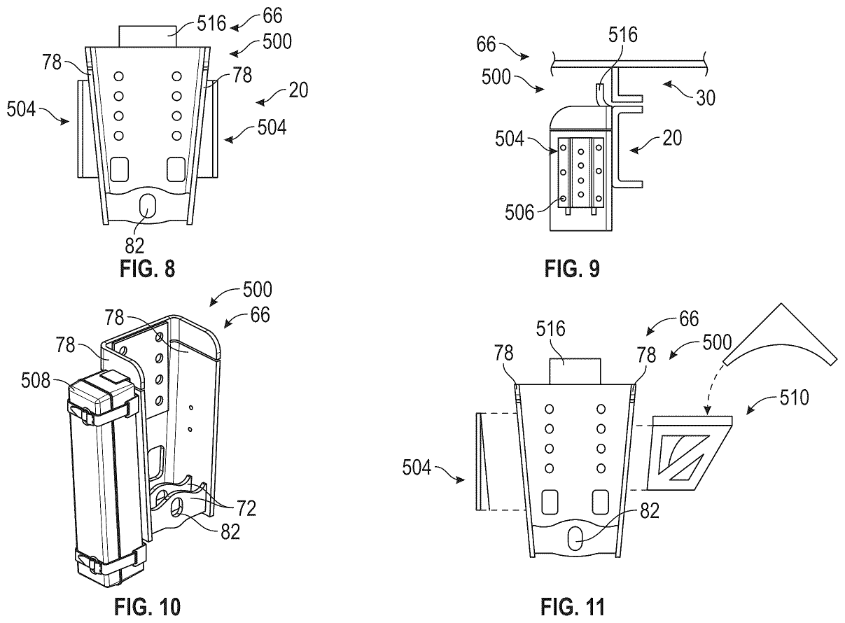

In general, the adapter plate 504 may adjust a mounting angle (e.g., an angle relative to a ground plane on which the vehicle 10 travels) that a component mounts to the universal bracket 500. By way of example, the sidewalls 78 on the universal bracket 500 may be angled (e.g., not perpendicular) relative to a ground plane and the adapter plate 504 may include a complementary angled wall that orients a mounting surface of the adapter plate 504 in a perpendicular orientation relative to the ground plane (see, e.g., FIG. 8). In some embodiments, the adapter plate 504 includes one or more adapter apertures 506 that align with a bolting pattern on a component and enable the component to be coupled (e.g., bolted) to the adapter plate 504. The particular mounting pattern defined by the adapter apertures 506 of the adapter plate 504 may depending on the component being coupled thereto (see, e.g., FIG. 7 and FIG. 9). In some embodiments, the universal bracket 500 may include an adapter plate 504 coupled to one of the sidewalls 78. In some embodiments, the universal bracket 500 may include an adapter plate 504 coupled to both of the sidewalls 78.

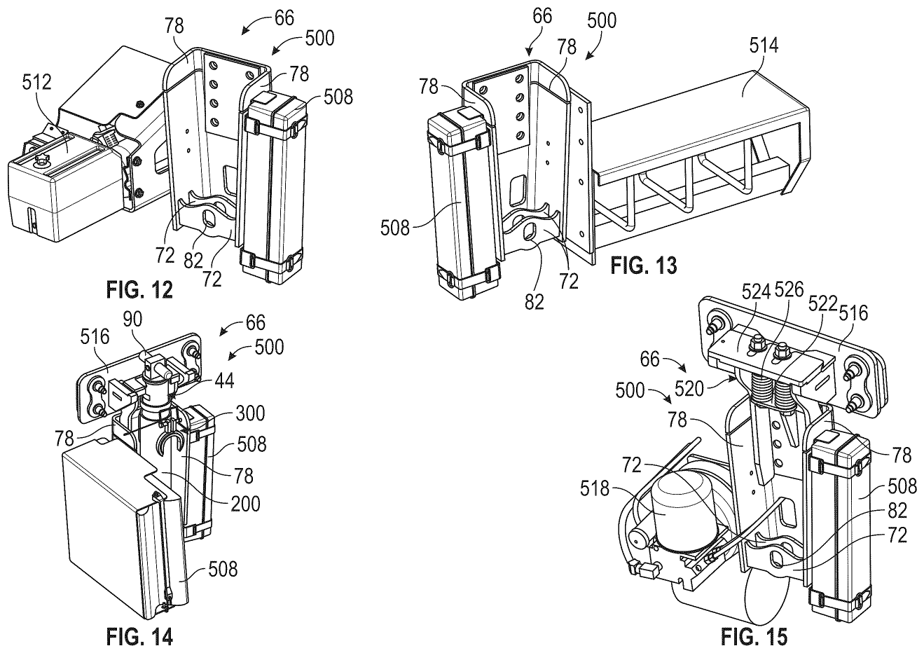

According to an exemplary embodiment, the universal bracket 500 may be coupled to the chassis 20 (e.g., to a frame rail of the chassis 20, as shown in FIG. 9), the lift cylinder assembly 44, and at least one additional component. By way of example, a spill kit 508 may be coupled to one of the sidewalls 78 (e.g., either directly or via the adapter plate 504) of the universal bracket 500, as shown in FIG. 10. In some embodiments, the universal bracket 500 may include an adapter plate 504 coupled to one of the sidewalls 78 and a wheel chock holder 510 coupled to the other sidewall 78, as shown in FIG. 11. In some embodiments, the universal bracket 500 may include the spill kit 508 coupled to one of the sidewalls 78 (e.g., either directly or via the adapter plate 504) and a service lift pump 512 coupled to the other sidewall 78 (e.g., either directly or via the adapter plate 504), as shown in FIG. 12. In some embodiments, the service lift pump 512 may be configured to supply hydraulic fluid to the lift cylinder assembly 44.

In some embodiments, the spill kit 508 may be coupled to one of the sidewalls 78 of the universal bracket 500 and a tire chain holder 514 may be coupled to the other sidewall 78 (e.g., either directly or via the adapter plate 504) of the universal bracket 500, as shown in FIG. 13. In some embodiments, the universal bracket 500 includes multiple spill kits 508 coupled thereto, as shown in FIG. 14. For example, the universal bracket 500 may include a first spill kit 508 coupled to one of the sidewalls 78 (e.g., either directly or via the adapter plate 504), and a second spill kit 508 coupled to the other sidewall 78 (e.g., either directly or via the adapter plate 504. FIG. 14 further shows the lift cylinder assembly 44 and the sleeve 200 coupled between the universal bracket 500 and a body plate 516. The body plate 516 may be coupled to the body 30 (e.g., similar to the body bracket assembly 60). In some embodiments, the universal bracket 500 may include an air dryer 518 coupled to one of the sidewalls 78 (e.g., either directly or via the adapter plate 504) and the spill kit 508 coupled to the other sidewall 78 (e.g., either directly or via the adapter plate 504), as shown in FIG. 15.

According to an exemplary embodiment, the lift cylinder assembly 44 may be removable from the universal bracket 500 (e.g., by removing the bolts 84 and the eyebolt 90) and a tiedown assembly 520 may be installed on the universal bracket 500 (see, e.g., FIGS. 15-17). In general, the tiedown assembly 520 is configured to prevent unintended lifting of the body 30 relative to the chassis 20. The universal bracket 500 facilitates coupling either the tiedown assembly 520 of the lift cylinder assembly 44 between the chassis 20 and the body 30, which saves mounting space along the chassis 20 by not requiring separate mounting locations for the lift cylinder assembly 44 and the tiedown assembly 520.

FIG. 15 shows an exemplary embodiment of the tiedown assembly 520 coupled between the universal bracket 500 and the body plate 516. The tiedown assembly 520 may include a lower tie down plate 522, an upper tie down plate 524, and a pair of tie down springs 526 coupled between the lower tie down plate 522 and the upper tie down plate 524. The lower tie down plate 522 is coupled to the universal bracket 500 and the upper die down plate 524 is coupled to the body plate 516. The tie down springs 526 are configured to provide a biasing force in a direction that opposes displacement between the chassis 20 and the body 30.

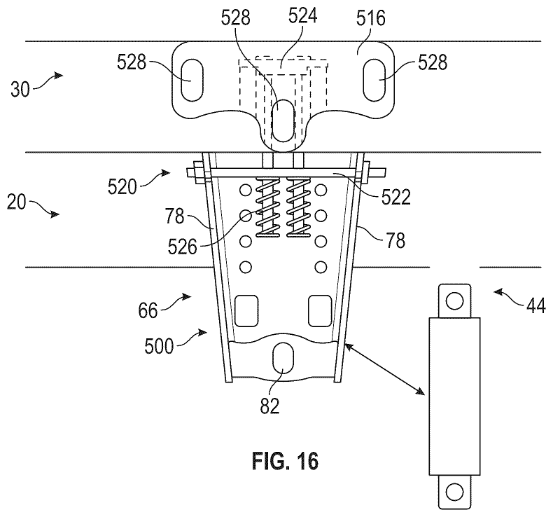

According to an exemplary embodiment, the body plate 516 may include a plurality of mounting lugs 528, as shown in FIG. 16. By way of example, the mounting lugs 528 may be spaced along a longitudinal direction of the chassis 20 to accommodate varying mounting positions of the universal bracket 500 on the chassis 20. For example, the chassis 20 may include various components mounted thereon, such as, fuel tanks, axles, air tanks, batteries. Depending on the configuration of the vehicle 10 and the components mounted to the chassis 20, the mounting location for the universal bracket 500 along the chassis 20 may vary. The different positions of the mounting lugs 528 along the chassis 20 ensure that the lift cylinder assembly 44 may be coupled to the body plate 516, even if the mounting location of the universal bracket 500 is moved from its standard position (e.g., coupling to the center mounting lug 528). In some embodiments, the body plate 516 includes more or less than three mounting lugs 528.

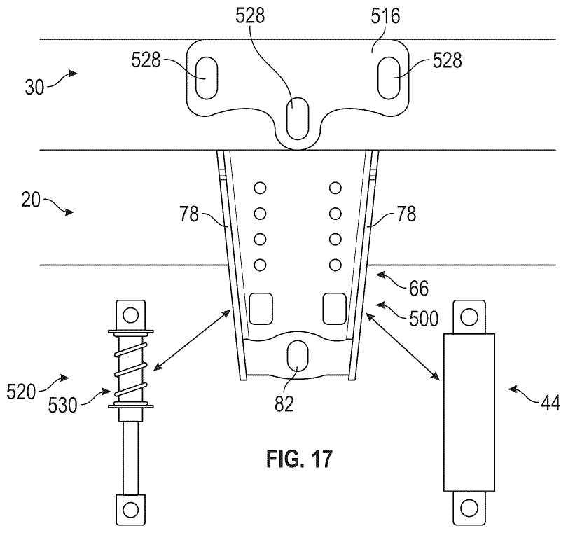

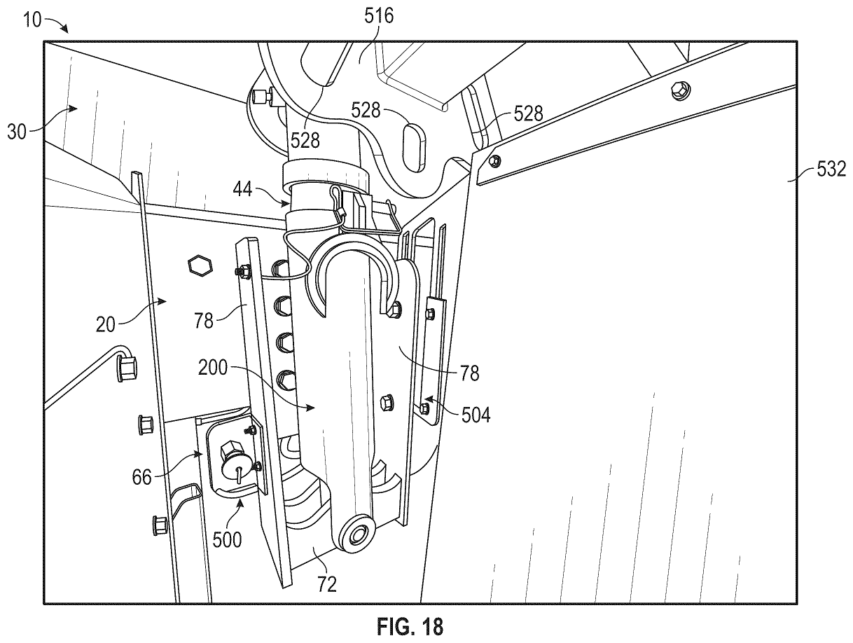

According to an exemplary embodiment, the tiedown assembly 520 may include a tie down strut 530, as shown in FIG. 17. The tie down strut 530 may be installed when body lifting functionality is not required, and the lift cylinder assembly 44 may be installed when body lifting functionality is required. For example, the universal bracket 500, and the vehicle 10, may be configurable between an A-kit where the tie down strut 530 is installed on the universal bracket 500 (e.g., coupled between the bolt connecting members 72 (via the apertures 82) and the body plate 516) and lifting or propping operation between the chassis 20 and the body 30 is prevented, and a B-kit where the lift cylinder assembly 44 is installed on the universal bracket 500 and lifting or propping operation between the chassis 20 and the body 30 is enabled.

FIG. 18 shows an exemplary embodiment of the universal bracket 500 installed on the vehicle 10. The universal bracket 500 is coupled to a frame rail of the chassis 20, and a mudflap 532 is coupled to one of the sidewalls 78 via the adapter plate 504. In the illustrated embodiment, the lift cylinder assembly 44 is coupled between the universal bracket 500 and the body plate 516, with the leftmost (e.g., from the perspective of FIG. 18) mounting lug 528 being coupled to the second end 58 of the lift cylinder assembly 44. In some embodiments, the leftmost mounting lug 528 shown in FIG. 18 is a forward most mounting lug 528 (e.g., toward the front end of the vehicle 10), which accommodates for the universal bracket 500 being mounting in a location on the chassis 20 that is forward of a standard mounting location. In some embodiments, when the lift cylinder assembly 44 and the tiedown assembly 520 are both selectively removable from the universal bracket 500, only a single mounting lug 528 may be arranged on the body plate 516.

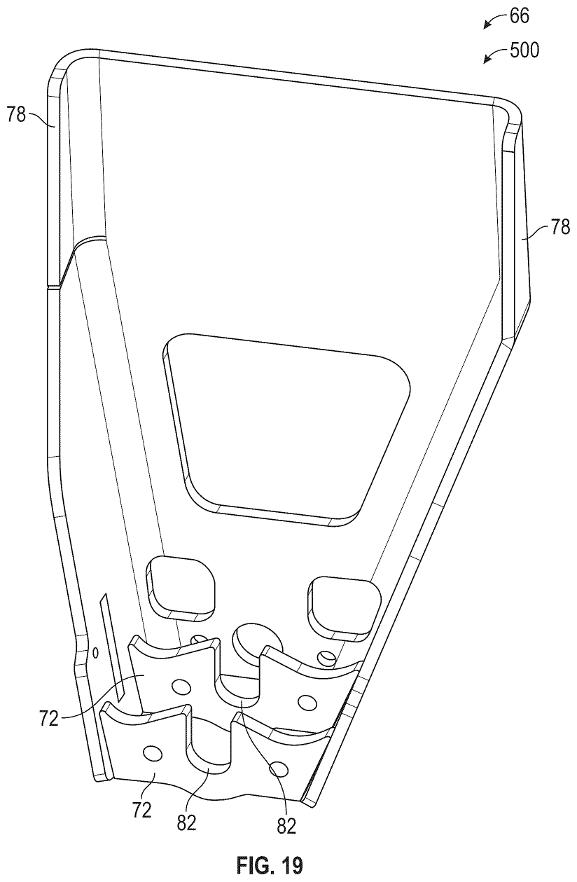

In some embodiments, the apertures 82 in the bolt connecting members 72 may include an open top end, as shown in FIG. 19. The open top end defined by the apertures 82 may aid is efficiently removing/installing the lift cylinder assembly 44 and/or the tie down strut 530 on the universal bracket 500.

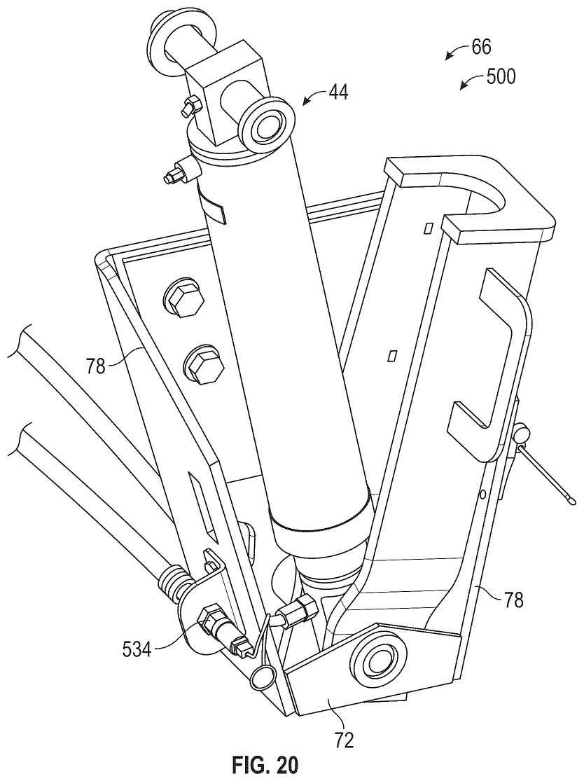

In some embodiments, a hydraulic quick-disconnect fitting 534 may be coupled to one of the sidewalls 78 of the universal bracket 500, as shown in FIG. 20. In this way, for example, the universal bracket 500 may make the routing of hydraulic lines to and from the lift cylinder assembly 44 more efficient.

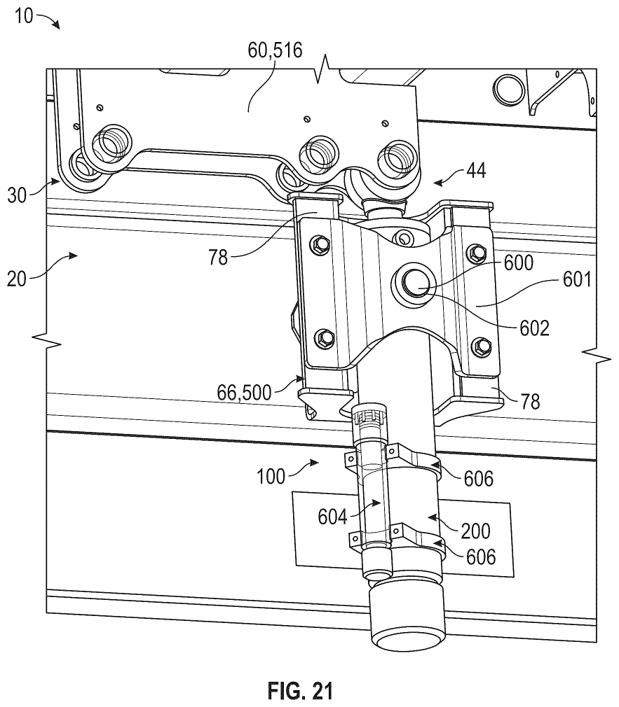

FIGS. 21-23 illustrate an exemplary embodiment of the lift cylinder assembly 44 and the propping system 100 coupled between the chassis 20 and the body 30. In some embodiments, the lift cylinder 44 and the propping system 100 are coupled between the bracket 66 (e.g., the universal bracket 500) and the body bracket assembly 60 or the body plate 516. In some embodiments, the body plate 516 is included within the body bracket assembly 60.

In the illustrated embodiment, the sleeve 200 includes a pair of rods or trunnions 600 that extend outwardly from an outer perimeter of the sleeve 200. A sleeve coupling plate 601 is coupled between the sidewalls 78 of the bracket 66 and includes an aperture or mounting hole 602 through which one of the trunnions 600 is received. The other trunnion 600 is received within a corresponding aperture or mounting hole within the bracket 66 (e.g., the universal bracket 500 may include an aperture or mounting hole for one of the trunnions 600). In some embodiments, the trunnions 600 and mounting holes 602 may replace the bolt connecting members 72 and apertures 82 of the bracket 66 to facilitate coupling the lift cylinder assembly 44 and the propping system 100 to the bracket 66.

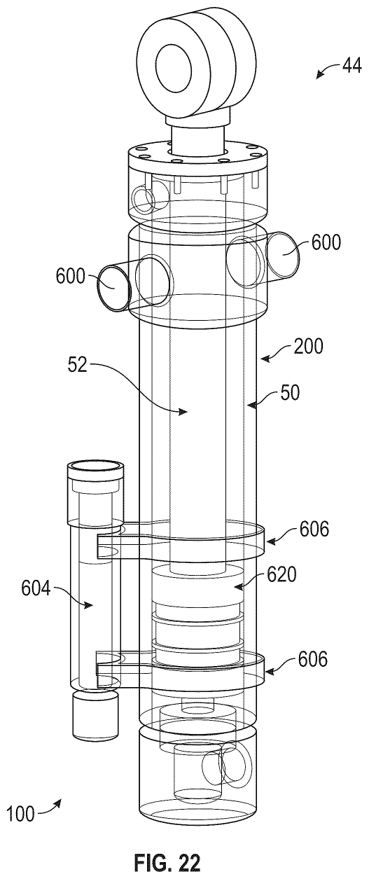

According to an exemplary embodiment, the propping system 100 includes a biasing element, a compliance element, a spring, a mechanical spring, a gas spring, or a pneumatic spring, shown as accumulator 604. In some embodiments, the accumulator 604 is coupled to an outer surface or outer periphery of the sleeve 200 by one or more ring brackets 606 (e.g., a pair of ring brackets 606), as shown in FIGS. 21 and 22. In general, the accumulator 604 is configured to apply a tiedown force that acts on the lift cylinder assembly 44 in a direction that urges the rod 52 to retract within the cylinder housing 50, which holds the body 30 against the chassis 20 but also provides some compliance (e.g., a spring-like force) to the system and allows the chassis 20 to flex during operation of the vehicle 10. In some embodiments, the accumulator 604 includes a gas spring in the form of a volume of pressurized air or gas that acts on a floating piston. In some embodiments, the accumulator 604 includes a gas spring in the form of a bladder of pressurized gas or air that acts on hydraulic fluid supplied within the accumulator 604. In some embodiments, the accumulator 604 includes a mechanical spring that acts on a floating piston. Regardless of the particular implementation of the accumulator 604, the accumulator 604 includes an outlet port 608 that is selectively connected to the lift cylinder assembly 44 to provide the tiedown force thereon, which acts to prevent the body 30 from being lifted relative to the chassis 20.

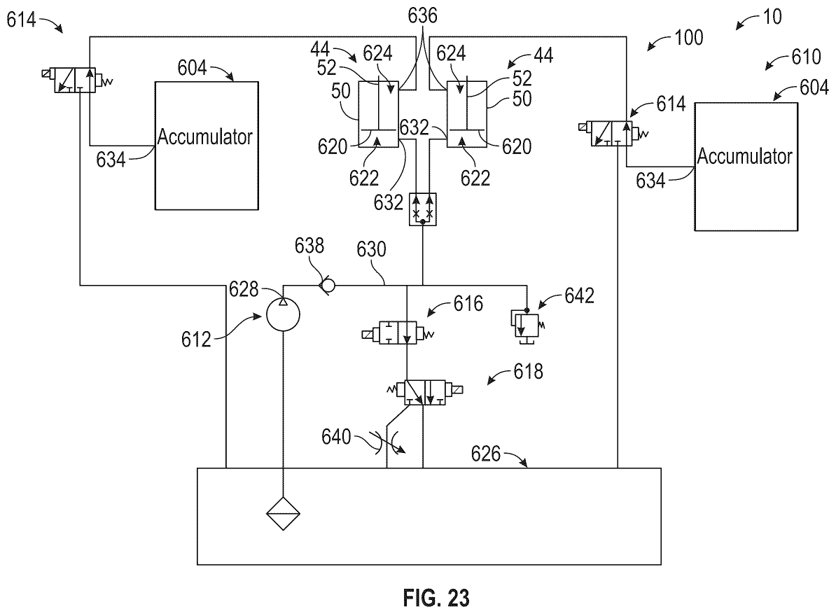

With specific reference to FIGS. 22-23, the propping system 100 may include a hydraulic circuit or hydraulic system 610 that controls operation of a pair of the lift cylinder assemblies 44 (e.g., one coupled between the chassis 20 and the body 30 on each lateral side of the vehicle 10) and, thereby, the raising and lowering of the body 30 relative to the chassis 20. In some embodiments, the inclusion of the accumulators 604 and the hydraulic circuit 610 described herein negate the need to include the locking member 300 in the propping system 100.

In general, the hydraulic circuit 610 is configured to provide three modes of operation: (1) a ride or tiedown mode, (2) a body lift mode, and (3) a body lower mode. In the tiedown mode, the body 30 is held down against the chassis 20, for example, by the weight of the body 30 and the biasing force provided by the accumulators 604. In the body lift mode, the body 30 is raised relative to the chassis 20. In the body lower mode, the body 30 is lowered relative to the chassis 20. According to an exemplary embodiment, the hydraulic circuit 610 includes a plurality of valves that facilitate selective switching between the three modes of operation. For example, the hydraulic circuit 610 may include a pump 612, a pair of accumulator valves 614, a drain valve 616, and a throttle drain valve 618 that control operation of the lift cylinder assemblies 44 in the three modes of operation. Both of the lift cylinder assemblies 44 include the cylinder rod 52 that is slidably received within the cylinder housing 50. A piston 620 is coupled to each of the cylinder rods 52 and divides an internal volume of the cylinder housing 50 into a piston chamber 622 where hydraulic fluid acts on one side of the piston 620 and a rod chamber 624 where hydraulic fluid acts on an opposing side of the piston 620 (e.g., a side of the piston 620 that the cylinder rod 52 is coupled to).

According to an exemplary embodiment, the pump 612 is configured to draw hydraulic fluid (e.g., oil) from a tank or reservoir 626 and furnish the hydraulic fluid at increased pressure to a pump outlet 628. The pump outlet 628 is in fluid communication with a supply conduit or line 630. The piston chambers 622 are in fluid communication with the supply conduit 630, for example, via a piston port 632 of the lift cylinder assemblies 44. The accumulator valves 614 are configured to selectively provide or inhibit fluid communication between the accumulators 604 and the rod chambers 624. For example, the accumulator valves 614 may be normally biased (e.g., by a spring) into a first position where fluid communication is provided between an inlet port 634 of the accumulators 604 and the rod chambers 624 (e.g., via a rod port 636). The accumulator valves 614 may be selectively moved or actuated (e.g., by a solenoid) to a second position where the inlet ports 634 are blocked and fluid communication is provided between the rod chambers 624 and the tank 626.

The drain valve 616 is in fluid communication with the supply conduit 630 downstream of the pump outlet 628 and downstream of a check valve 638 that is configured to only allow fluid to flow in a direction from the pump outlet 628 toward the piston chambers 622. The throttle drain valve 618 is in fluid communication with the drain valve 616 and is arranged downstream of the drain valve 616. In some embodiments, the drain valve 616 is normally biased (e.g., by a spring) into a first drain position where fluid communication is provided between the supply conduit 630 (and thereby the piston chambers 622) and the throttle drain valve 618. The drain valve 616 may be selectively moved or actuated (e.g., by a solenoid) to a second drain position where fluid communication is inhibited or prevented between the supply conduit 630 (and thereby the piston chambers 622) and the throttle drain valve 618. In some embodiments, the throttle drain valve 618 is normally biased (e.g., by a spring) into a first throttle position where fluid communication is provided between the drain valve 616 and the tank 626. The throttle drain valve 618 may be selectively moved or actuated (e.g., by a solenoid) to a second throttle position where fluid communication is provided between the drain valve 616 and a throttle or variable orifice 640. A pressure relief valve 642 is in fluid communication with the supply conduit 630 and is configured to selectively provide fluid communication between the supply conduit 630 and the tank 626 in response to a pressure in the supply conduit being greater than or equal to a threshold pressure.

In some embodiments, each of the accumulator valves 614, the drain valve 616, and the throttle drain valve 618 is a solenoid-operated electrohydraulic valve and is normally-biased into the position illustrated in FIG. 23 (e.g., the first position, the first drain position, and the first throttle position). In some embodiments, each of the accumulator valves 614, the drain valve 616, and the throttle drain valve 618 is in communication with a controller (e.g., a controller having a processing circuit with a processor and memory storing instructions that are executed by the processor), and the controller is configured to selectively move or actuate the accumulator valves 614, the drain valve 616, and the throttle drain valve 618 between their respective positions. For example, the controller may be configured to selectively energize a solenoid of the accumulator valves 614, the drain valve 616, and/or the throttle drain valve 618 to move or actuate the accumulator valves 614, the drain valve 616, and/or the throttle drain valve 618 away from their respective normally-biased positions (e.g., to the second position, the second drain position, and the second throttle position).

During operation of the vehicle 10, the accumulator valves 614, the drain valve 616, and the throttle drain valve 618 may control the operation of the propping system 100 and selectively switch between the tiedown mode, the body lift mode, and the body lower mode. In the tiedown mode, each of the accumulator valves 614, the drain valve 616, and the throttle drain valve 618 is in their normally-biased position. For example, the accumulator valves 614 are in the first position, the drain valve 616 is in the first drain position, and the throttle drain valve 618 is in the first throttle position. With the drain valve 616 in the first drain position and the throttle drain valve 618 in the first throttle position, fluid communication is provided between the piston chambers 622 and the tank 626, which ensures that the lift cylinder assemblies 44 are fully retracted and the body 30 is lowered and supported on the chassis 20. The accumulator valves 614 being in the first position, provides fluid communication between the accumulators 604 and the rod chambers 624, which provides the spring force supplied by the accumulators 604 against the rod side of the piston 620 and biases the lift cylinder assemblies 44 to remain in the retracted position. In this way, for example, the body 30 is urged by the accumulators 604 to be held against the chassis 20 (e.g., the biasing force provided by the accumulators 604 acts against the cylinder rods 52 extending) and the body 30 is tied down against the chassis 20. The spring-like biasing force provided by the accumulators 604 also allows for some compliance between the body 30 and the chassis 20 to account for flexing of the chassis 20 during operation of the vehicle 10.

In the body lift mode, each of the accumulator valves 614, the drain valve 616, and the throttle drain valve 618 is moved or actuated away from their normally-biased position. For example, the accumulator valves 614 are moved to the second position, the drain valve 616 is moved to the second drain position, and the throttle drain valve 618 is moved to the second throttle position. With the accumulator valves 614 in the second position, the accumulators 604 are disconnected from the rod chambers 624, and the rod chambers 624 are placed in fluid communication with the tank 626. With the drain valve 616 in the second drain position, the drain valve 616 prevents fluid communication between the supply conduit 630, and thereby the piston chambers 622, and the tank 626. Even though the drain valve 616 prevents fluid communication between the supply conduit 630 and the throttle drain valve 618 in the second drain position, the throttle drain valve 618 is actuated to the second throttle position at any time the body 30 is being raised or lowered relative to the chassis 20 to ensure that fluid is drained to the tank 626 through the throttle 640, rather than being drained directly to the tank 626.

With the accumulator valves 614 in the second position and the drain valve 616 in the second drain position, the pump 612 may then supply pressurized hydraulic fluid to the supply conduit 630 and the piston chambers 622. With the rod chambers 624 being in fluid communication with the tank 626, the pressurized fluid supplied to the piston chambers 622 by the pump 612 acts to extend the lift cylinder assemblies 44 and raise the body 30 relative to the chassis 20. In some embodiments, an actuator stroke defined by the lift cylinder assemblies 44 (e.g., how much the cylinder rod 52 is allowed to extend out of the cylinder housing 50) limits the amount the body 30 is allowed to be raised relative to the chassis 20.

Once the body 30 has been raised relative to the chassis 20 in the body lift mode, the body 30 may be selectively lowered back down to the chassis 20 by transitioning to the body lower mode. In the body lower mode, the accumulator valves 614 remain in the second position, the drain valve 616 is moved or actuated back to the first drain position, and the throttle drain valve 618 remains in the second throttle position. With the drain valve 616 moved to the first drain position, fluid communication is provided between the piston chambers 622 and the tank 626 through the throttle 640, and the weight of the body 30 acting on the lift cylinder assemblies 44 causes the lift cylinder assemblies 44 to retract and lower the body 30 onto the chassis 20. The throttle 640 is configured to limit the speed at which the body 30 is lowered relative to the chassis 20. In some embodiments, the opening or orifice defined by the throttle 640 may be selectively adjusted (e.g., by the controller) to control the lowering speed of the body 30.

Once the body 30 is lowered onto the chassis 20, the accumulator valves 614 may be moved or actuated to the first position and the throttle drain valve 618 may be moved or actuated to the first throttle position to transition back to the tiedown mode. Accordingly, the inclusion of the accumulators 604 and the hydraulic circuit 610 provide service lift operation (e.g., propping), service lowering operation, and tiedown operation between the body 30 and the chassis 20.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the cylinder propping system as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body supported on the chassis; and
a universal bracket coupled to the chassis, wherein the universal bracket is coupled to (a) a lift cylinder assembly that is configured to lift the body relative to the chassis, or (b) a tiedown assembly that is configured to oppose movement of the body relative to the chassis, and wherein the universal bracket includes a sidewall that is coupled to a debris deflection device, a spill kit, a tire chain holder, an air dryer, a wheel chock holder, or a service lift pump.

2. The refuse vehicle of claim 1, wherein the lift cylinder assembly is coupled to the universal bracket, and wherein the debris deflection device, in the form of a mudflap, is coupled to the sidewall by an adapter plate.

3. The refuse vehicle of claim 1, wherein the sidewall is a first sidewall and the universal bracket further includes a second sidewall.

4. The refuse vehicle of claim 3, wherein the spill kit is coupled to the first sidewall and the service lift pump, the air dryer, or the tire chain holder is coupled to the second sidewall.

5. The refuse vehicle of claim 1, wherein the tiedown assembly includes a spring, and wherein both the lift cylinder assembly and the tiedown assembly are coupled to the universal bracket.

6. The refuse vehicle of claim 5, wherein the spring provides a biasing force in a direction that opposes the body from being lifted relative to the chassis.

7. The refuse vehicle of claim 5, wherein the spring provides a biasing force in a direction that opposes the lift cylinder assembly from extending.

8. The refuse vehicle of claim 1, wherein the lift cylinder assembly is coupled to the universal bracket.

9. The refuse vehicle of claim 8, further comprising a hydraulic circuit fluidly coupled to the lift cylinder assembly and including an accumulator, an accumulator valve, a drain valve, and a throttle drain valve, and wherein the hydraulic circuit is configured to control operation of the lift cylinder assembly in a tiedown mode, a body lift mode, and a body lower mode.

10. The refuse vehicle of claim 9, wherein when the hydraulic circuit is in the tiedown mode, the accumulator valve is configured to provide fluid communication between the accumulator and a rod chamber of the lift cylinder assembly to provide a biasing force from the accumulator that acts in direction that opposes the lift cylinder assembly from extending, and thereby acts to oppose the body from being lifted relative to the chassis.

11. The refuse vehicle of claim 10, wherein when the hydraulic circuit is in the tiedown mode, the drain valve and the throttle drain valve are configured to provide fluid communication between a piston chamber of the lift cylinder assembly and a tank of the hydraulic circuit.

12. The refuse vehicle of claim 9, wherein when the hydraulic circuit is in the body lift mode, the accumulator valve is configured to provide fluid communication between a rod chamber of the lift cylinder assembly and a tank of the hydraulic circuit, and the drain valve is configured to prevent fluid communication between a piston chamber of the lift cylinder assembly and the tank.

13. The refuse vehicle of claim 12, wherein when the hydraulic circuit is in the body lift mode, a pump of the hydraulic circuit is configured to supply pressurized hydraulic fluid to the piston chamber so that the lift cylinder assembly extends and the body is lifted relative to the chassis.

14. The refuse vehicle of claim 9, wherein when the hydraulic circuit is in the body lower mode, the accumulator valve is configured to provide fluid communication between a rod chamber of the lift cylinder assembly and a tank of the hydraulic circuit, the drain valve and the throttle drain valve are configured to provide fluid communication between a piston chamber of the lift cylinder assembly and the tank through a throttle, so that the lift cylinder assembly retracts and the body is lowered relative to the chassis at a speed that is limited by the throttle.

15. A refuse vehicle comprising:
a chassis;
a body supported on the chassis;
a bracket coupled to the chassis;
a lift cylinder assembly coupled between the bracket and the body, wherein the lift cylinder assembly is configured to selectively raise and lower the body relative to the chassis; and
a propping system coupled to the lift cylinder assembly, wherein the propping system includes a pump, a tank, an accumulator, an accumulator valve, a drain valve, and a throttle drain valve, the propping system being configured to operate in:
a tie down mode where the accumulator valve is configured to provide fluid communication between the accumulator and a rod chamber of the lift cylinder assembly, wherein the accumulator provides a biasing force that acts in direction that opposes the body from being lifted relative to the chassis;
a body lift mode where the accumulator valve is configured to provide fluid communication between the rod chamber and the tank, the drain valve is configured to prevent fluid communication between a piston chamber of the lift cylinder assembly and the tank, and the pump is configured to supply pressurized hydraulic fluid to the piston chamber so that the body is lifted relative to the chassis; and
a body lower mode where the accumulator valve is configured to provide fluid communication between the rod chamber and the tank, and the drain valve and the throttle drain valve are configured to provide fluid communication between the piston chamber and the tank through a throttle, so that the body is lowered relative to the chassis at a speed that is limited by the throttle.

16. The refuse vehicle of claim 15, wherein the lift cylinder assembly is arranged within a sleeve, and wherein the accumulator is coupled to an outer periphery of the sleeve.

17. The refuse vehicle of claim 16, wherein the accumulator is coupled to the sleeve by a ring bracket.

18. The refuse vehicle of claim 15, wherein the bracket includes a sidewall that is coupled to a debris deflection device, a spill kit, a tire chain holder, an air dryer, a wheel chock holder, or a service lift pump.

19. The refuse vehicle of claim 18, wherein the sidewall is a first sidewall and the bracket further includes a second sidewall, and wherein the spill kit is coupled to the first sidewall and the service lift pump, the air dryer, or the tire chain holder is coupled to the second sidewall.

20. A propping system for a refuse vehicle comprising:
a lift cylinder assembly including a cylinder rod, a cylinder housing, a piston, a piston chamber defined within the cylinder housing, and a rod chamber defined within the cylinder housing;
a hydraulic circuit that includes a pump, a tank, an accumulator, an accumulator valve, a drain valve, and a throttle drain valve, wherein the hydraulic circuit is operable in a tiedown mode, a body lift mode, and a body lower mode;
in the tiedown mode, the accumulator valve is configured to provide fluid communication between the accumulator and the rod chamber to provide a biasing force from the accumulator that acts in direction that opposes the cylinder rod from extending from the cylinder housing;
in the body lift mode, the accumulator valve is configured to provide fluid communication between the rod chamber and the tank, the drain valve is configured to prevent fluid communication between the piston chamber and the tank, and the pump is configured to supply pressurized hydraulic fluid to the piston chamber so that the cylinder rod is extended from the cylinder housing; and
in the body lower mode, the accumulator valve is configured to provide fluid communication between the rod chamber and the tank, and the drain valve and the throttle drain valve are configured to provide fluid communication between the piston chamber and the tank through a throttle, so that the cylinder rod is retracted into the cylinder housing at a speed that is limited by the throttle.
